(19) United States
(12) Patent Application Publication
(10) Pub. No.: US 2016/0286007 A1
(43) Pub. Date: Sep. 29, 2016

(54) DATA GATHERING BRIDGE

(71) Applicant: TMM DATA LLC, Philipsburg, PA (US)

(72) Inventors: Robert L. Selfridge, Philipsburg, PA (US); Wesley Boyd, Kylertown, PA (US); Tyler Napikoski, Lewistown, PA (US); Dan Kovacik, State College, PA (US)

(21) Appl. No.: 15/080,368

(22) Filed: Mar. 24, 2016

Related U.S. Application Data
(60) Provisional application No. 62/139,440, filed on Mar. 27, 2015.

(51) Int. Cl. H04L 29/06; G06F 17/30; H04L 29/08

(52) U.S. Cl. CPC H04L 67/42; H04L 67/1097; G06F 17/30864

(57) ABSTRACT

A method for data packet communication between a data beacon and a command-and-control server that are located within separate networks can comprise accessing a beacon identification indicator. The method can also comprise generating a command-request data packet comprising the beacon identification indicator and a public network address associated with the data beacon. Additionally, the method can comprise transmitting the command-request data packet to a command-and-control server address. The method can also comprise receiving a command data packet from the command-and-control server that comprises a command to query a local database for specific data elements. The method can then include querying the local database for the specific data elements. Further, the method can include generating a response data packet that comprises the specific data elements. Further still, the method can include transmitting the response data packet to the command-and-control server address.

### CROSS-REFERENCE TO RELATED APPLICATIONS

This application claims the benefit of and priority to, U.S. Provisional Application Ser. No. 62/139,440, filed on Mar. 27, 2015, entitled “DATA GATHERING BRIDGE,” which is incorporated by reference herein in its entirety.

### BACKGROUND OF THE INVENTION

1. Technical Field

The present invention relates generally to data collection, management, and sharing.

2. Background and Relevant Art

Data collection, management, and sharing are ubiquitous in our society and in the information age. Many individuals and organizations create, consume, and maintain vast quantities of data—they have data in spreadsheets, textual documents, databases, enterprise systems, third-party systems, and other data-storage systems. As such, individuals and organizations face the challenge of sharing data across platforms and maintaining datasets.

In many cases, the data of interest is highly valuable and protected behind one or more network security schemes. For example, a particular group of market data may be stored within a firewall-protected database. Additionally, due to stringent security protocols and approval processes, it may be extremely difficult to create rules and exceptions that allow parties of interest to access the firewall-protected data.

Accordingly, there are a number of disadvantages in the art of data collection and management that can be addressed.

### BRIEF SUMMARY OF THE INVENTION

Implementations of the present invention comprise systems, methods, and apparatus configured to allow easily deployable, cross-network solutions for accessing and analyzing database information. For example, implementations of the present invention comprise physical units and/or software applications that can be in communication with a local intranet. The physical units and/or software applications can then gather the necessary data and information, process the data, and/or provide the data to an external server, without requiring highly technical and difficult-to-implement adjustments to an organization's network security policies.

Implementations of the present invention can comprise a computer system for data packet communication between a data beacon and a command-and-control server that are located within separate networks. The computer system can comprise one or more processors and one or more computer-readable media having stored thereon executable instructions that when executed by the one or more processors configure the computer system to perform one or more acts.

The performed acts can include detecting an initiation event generated by a computer-based timer. The performed acts can also include accessing, from the one or more computer-readable media, a beacon identification indicator. The beacon identification indicator can comprise a pre-assigned identifier associated with the data beacon. The performed acts can also include accessing, from the one or more computer-readable media, a command-and-control server address. The command-and-control server address comprises a public network address associated with a command-and-control server.

The performed acts can also include generating a command-request data packet comprising the beacon identification indicator and a public network address associated with the data beacon. Additionally, the performed acts can include transmitting the command-request data packet to the command-and-control server address. In addition, the performed acts can include receiving a command data packet from the command-and-control server. The command data packet can comprise a command to query a local database for specific data elements. The performed acts can also comprise querying the local database for the specific data elements. Further, the performed acts can comprise generating a response data packet. Further still, the response data packet can comprise the specific data elements. The performed acts can also comprise transmitting the response data packet to the command-and-control server address.

Additional or alternative implementations of the present invention can comprise a computer system for data packet communication between a command-and-control server and a data beacon that are located within separate networks. The computer system can comprise one or more processors and one or more computer-readable media having stored thereon executable instructions that when executed by the one or more processors configure the computer system to perform one or more acts.

The performed acts can include receiving, from a client computer, a database command. The database command can comprise a database identification indicator that designates a target database. The database command can also comprise a request for specific data elements within the target database. Additionally, the database command can comprise a data processing command. The performed acts can also include identifying, from within a digitally stored database-to-beacon reference table, a target beacon identification indicator for a data beacon that is associated with the target database.

In addition, the performed acts can include generating a command data packet that comprises the request for the specific data elements within the target database. The performed acts can also include associating the command data packet with the beacon identification indicator. Additionally, the performed acts can include transmitting the command data packet to a network address associated with the target beacon identification indicator. The performed acts can include receiving, from the data beacon, a response data packet. The response data packet can comprise the specific data elements. Further, the performed acts can include executing the data processing command on the specific data elements. Further still, the performed acts can include sending the resulting data to the client computer for display.

Additionally, further or alternative implementations of the present invention can include a computerized method for execution on a computer system. The computer system can comprise one or more processors, system memory, and one or more computer-readable media storing computer-executable instructions. The method executed by the computer system can be for data packet communication between a data beacon and a command-and-control server that are located within separate networks.

The method can comprise the act of accessing, from the one or more computer-readable media, a beacon identification indicator. The beacon identification indicator can comprise a pre-assigned identifier associated with the data beacon. The method can also comprise the act of generating a command-request data packet comprising the beacon identification indicator and a public network address associated with the data beacon. Additionally, the method can comprise the act of transmitting the command-request data packet to a command-and-control server address.

The method can also comprise the act of receiving a command data packet from the command-and-control server. The command data packet can comprise a command to query a local database for specific data elements. Additionally, the method can comprise an act of querying the local database for the specific data elements. Further, the method can comprise an act of generating a response data packet. The response data packet can comprise the specific data elements. Further, still the method can comprise an act of transmitting the response data packet to the command-and-control server address.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic of a system for accessing data within a local network and providing the data to a client computer in accordance with implementations of the present invention;

FIG. 2 illustrates a schematic diagram of a portion of a system for data packet communication between a data beacon and a command-and-control server that are located within separate networks;

FIG. 3 illustrates a schematic diagram of a portion of a system for data packet communication between a command-and-control server and a data beacon 102 that are located within separate networks;

FIG. 4 illustrates a flowchart of an exemplary method implemented in accordance with implementations of the present invention; and

FIG. 5 illustrates a flowchart of an exemplary method implemented in accordance with implementations of the present invention.

### DETAILED DESCRIPTION OF THE PREFERRED EMBODIMENTS

The present invention extends to systems, methods, and apparatus configured to allow easily deployable, cross-network solutions for accessing and analyzing database information. For example, implementations of the present invention comprise physical units and/or software applications that can be in communication with a local intranet. The physical units and/or software applications can then gather the necessary data and information, process the data, and/or provide the data to an external server, without requiring highly technical and difficult-to-implement adjustments to an organization's network security policies.

In at least one implementation of the present invention, a data beacon can be connected to the local network. As used herein, a “data beacon” includes purpose-built computer hardware (e.g., embedded system, customized computer, etc.), general-purpose computer hardware (e.g., desktop computer, server, headless computer, etc.) and/or software applications or modules installed on one or more of purpose-built computer(s) and general-purpose computer(s). The data beacon is configured to receive database commands from a remote source (such as a command-and-control server) and apply the received database commands to a local database that is accessible to the data beacon.

In at least one implementation, the data beacon is highly integratable into a local intranet. For instance, an employee of an organization may simply plug the data beacon into an available Ethernet port within the intranet of interest. The data beacon can then be used to retrieve commands from an external command-and-control server, to access data from within the local network, and push data out to the command-and-control server, all without requiring changes to an organization's network policies (e.g., firewall rules, intrusion detection systems, port forwarding rules, etc.).

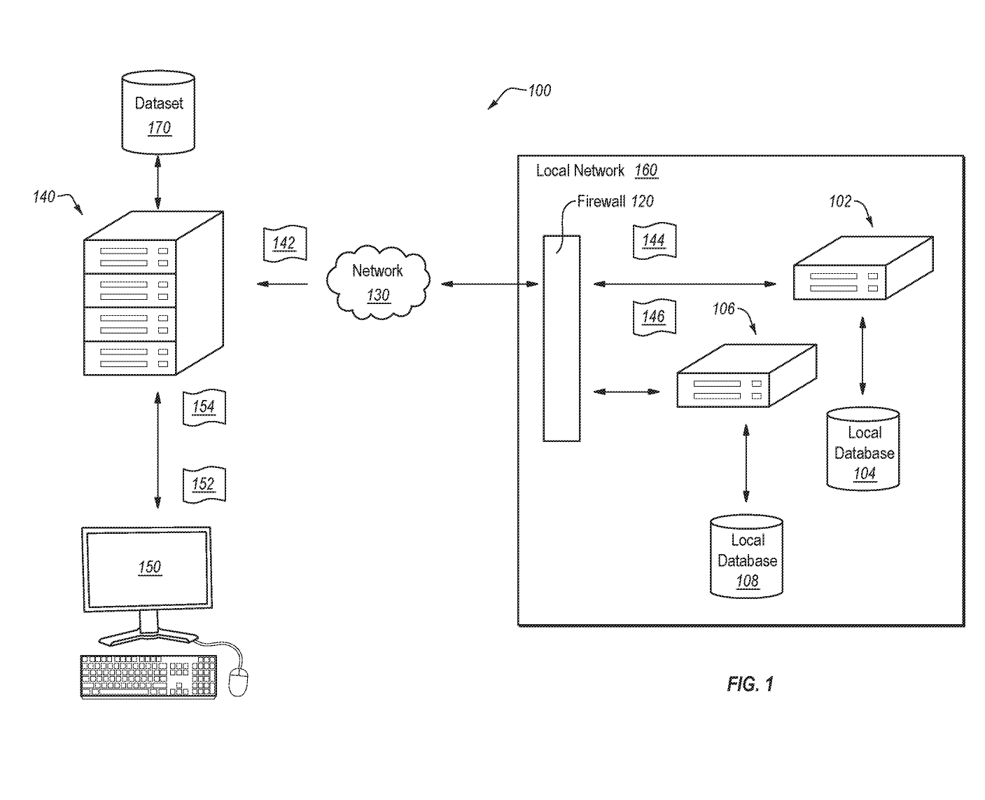

FIG. 1 depicts a schematic of a system 100 for accessing data within a local network 160 and providing the data to a client computer 150 in accordance with implementations of the present invention. In particular, FIG. 1 depicts a command-and-control server 140 that is in communication with a client computer 150. The client computer 150 may communicate with the command-and-control server 140 through a network (not shown) or through a direct communication line.

As used herein, the “client computer 150” may comprise a desktop computer, a laptop computer, a mobile computing device, such as a smartphone or tablet, or any other computing device. Additionally, the client computer 150 may be within the same local network as the command-and-control server 140 and/or within the local network 160. In contrast, in at least one implementation, the client computer 150 can be remote to command-and-control server 140 and/or the local network 160. Further, as used herein, the “command-and-control server 140” can comprise a single server and/or one or more distributed servers in the form of a “cloud network.”

The client computer 150 may generate database commands 152 directed towards the command-and-control server 140 that seek various data and data analytics from data stored within a target database (e.g., local database 104). As used herein, a “database” can comprise any information stored within an organized digital database, including standard database formats (e.g., ORACLE databases), structured data stored within computer storage, or individual data pieces that can be retrieved and put within a structured data set. For example, a user may desire information relating to financial statements stored on local database 104.

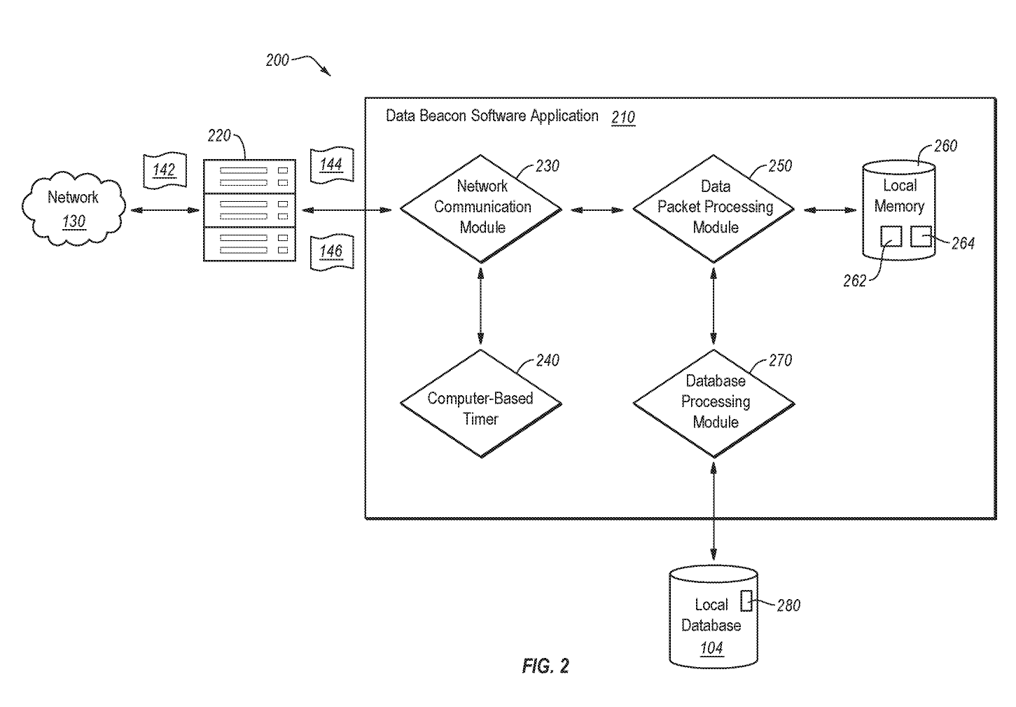

The command-and-control server 140 is in communication through a network 130 with a local network 160. As used herein, a local network 160 is a network that is at least partially partitioned from the Internet. For example, a local network 160 may be separated from the Internet by an internet gateway (shown as 220 in FIG. 2). The internet gateway 220 may comprise a router, a modem, a fiber channel, a network card, or any other connection capable of communicating over the Internet. Additionally, the internet gateway 220 can implement various network security features, such as, a firewall, a network address translation (NAT) service, or any other service or feature that at least partially shields the local network 102 from external communications.

As is often the case within conventional local networks, the local network 160 may comprise various security measures aimed at preventing data breaches and other intentional or unintentional security lapses. For example, FIG. 1 shows that local network 160 comprises a firewall 120. The firewall 120 may be configured to limit and analyze inbound communication to the local network 160. In various additional limitations, the firewall 120 may also limit and analyze outbound communications from the local network 160.

The firewall 120 may allow at least a portion of inbound network communications that are in response to previously sent outbound network communications. For example, a particular hardware or software module within the local network 160 may request information from an external server 140. The firewall 120 can identify the outbound information request, and in turn, identify the inbound response from the external server 140. In at least one implementation, the firewall 120 allows the inbound request to pass through the firewall 120 and into the local network 160. In contrast, if an inbound request is intercepted by the firewall 120 that was not in response to an outbound request and is otherwise not allowed by a specific firewall rule, the firewall 120 may block the inbound request.

As depicted in FIG. 1, the local area network 160 may also comprise a data beacon 102. The data beacon 102 may be in direct communication with the local network 160 through an Ethernet connection or a local Wi-Fi connection. The data beacon's position within the local network 160 can allow the data beacon 102 to send outbound requests to the command-and-control server 140 and receive inbound responses from the command-and-control server 140 through the firewall 120 (and through other network security measures). Additionally, the data beacon's position within the local network 160 can provide the data beacon 102 with direct access to various databases (including the local database 104).

In at least one implementation, an organization or multiple organizations may have multiple distinct data beacons 100, 106 placed within their respective local area networks 160 (also referred to herein as “intranets”). For instance, a single organization may comprise a specific data beacon 102 within its accounting department and a specific data beacon 106 within its human resources department. Each of the data beacons 102, 106 may be configured to communicate with separate local databases. For example, data beacon 102 communicates with local database 104 and data beacon 106 communicates with local database 108. Each data beacon 102, 106 can also individually communicate with the command-and-control server 140.

In at least one implementation, the system 100 is configured to allow a user at a client computer 150 to query data that is stored within local database 104. For example, upon receiving input from the user, the client computer 150 can generate a database command 152. The database command 152 may comprise a database identification indicator that designates a target database (e.g., local database 104), a request for specific data elements within the target database, and a data processing command. The client computer 150 can communicate the database command 152 to the command-and-control server 140.

As will be explained more fully herein, upon receiving the database command 152, the command-and-control server 140 can generate a command data packet 142 that is directed towards a particular data beacon (e.g., data beacon 102). The command data packet 142 may comprise a command to query a local database (e.g., local database 104) for specific data elements.

Periodically, the data beacon 102 can communicate a command-request data packet 144 to the command-and-control server 140. The command-request data packet 144 can comprise a digital communication that includes a target beacon identification indicator and the public network address for the data beacon 102. As used herein, a target beacon identification indicator comprises an identifier associated with a particular data beacon (e.g., data beacons 102, 106).

The target beacon identification indicator may comprise a name or variable that is assigned by an administrator to the particular data beacon. For example, the target beacon identification indicator may comprise a name that describes the local database(s) that the data beacon is in communication with. For instance, a target beacon identification indicator may be “ACME_HR_BEACON,” indicating that the target beacon is in communication with Acme's Human Resources database.

In at least one implementation, a data beacon can generate its own target beacon identification indicator based upon identified characteristics of the local network 160 and/or associated databases 104, 108. For example, the data beacon may query the local network 160 for all available databases. The data beacon may then generate a target beacon identification indicator that comprises identifiable information about each database. As such, a receiver of the command-request data packet 144 may be able to identify whether the data beacon is associated with any databases of interest, simply by analyzing the target beacon identification indicator. As will be explained more fully herein, the command-and-control server 140 uses the target beacon identification indicator to determine which commands should be sent to a particular data beacon 102.

Upon receiving the command-request data packet 144, the command-and-control server 140 can communicate the previously created command data packet 142 to the data beacon 102. The data beacon 102 can process the command data packet 142 and retrieve the requested specific data elements from the local database 104. The data beacon 102 can then generate a response data packet 146 that includes the specific data elements. The data beacon 102 can communicate the response data packet 146 to the command-and-control server 140.

The command-and-control server 140 can then extract the specific data elements from the response data packet 146. Upon extracting the specific data elements, the command-and-control server 140 then execute the data processing command, which was received in the database command 152, on the specific data elements. After processing data processing command on the specific data elements, the command-and-control server 140 can communicate the results of the data processing command to the client computer 150 in a resulting data packet 154.

FIG. 2 depicts a schematic diagram of a portion of a system 200 for data packet communication between a data beacon 102 and a command-and-control server 104 that are located within separate networks. In particular, FIG. 2 depicts a schematic diagram of modules within a data beacon software application 210. As used herein, a “module” means a set of one or more logical, computer-executable functions and/or one or more computer application sub-routines, which are executed by a computing device, such as the data beacon 102. One of skill will understand that the depiction of the data beacon software application 210 is merely exemplary, and that in alternate implementations, the same functions can be performed with modules in a different arrangement and/or with equivalent hardware devices.

In at least one implementation, the data beacon software application 210 can comprise a network communication module 230. The network communication module 230 may be in communication with a network 130 through an internet gateway 220 that at least to some extent controls the flow of data in and out of the local network. The network communication module 230 is configured to detect an initiation event generated by a computer-based timer 240. The computer-based timer 240 repeatedly generates the initiation event at a particular time frequency. For example, the computer-based timer can be set to generate an initiation event once every 15 seconds, every 30 seconds, every minute, every 15 minutes, every hour, once a day, or at specific times throughout a day, week, or month. As used herein, an initiation event is an alert, or digital notice, generated at a particular periodic timing.

Upon detecting the initiation event, the network communication module 230 can request instruction from the data packet processing module 250. The data packet processing module 250 accesses, from the one or more computer-readable media (e.g., local memory 260), a beacon identification indicator 262. As used herein, the beacon identification indicator 262 comprises a pre-assigned identifier associated with the data beacon. The beacon identification indicator 262 may comprise the same information as the target beacon identification indicator, which is also described herein. In at least one implementation, the command-and-control server 140 uses the beacon identification indicator 262 to identify a particular data beacon 102.

The data packet processing module 250 can also access, from the one or more computer-readable media (e.g., local memory 260), a command-and-control server address 264. The command-and-control server address 264 comprises a public network address (e.g., a public IP address and/or network port) associated with the command-and-control server 140.

Once the above information is gathered, the data packet processing module 250 generates a command-request data packet 144. The command-request data packet 144 comprises the gathered beacon identification indicator 262 and a public network address associated with the data beacon 102. The public network address can be a public IP address and network port necessary to communicate with the data beacon 102 through the network 130. The network communication module 230 can then transmit the command-request data packet 144 to the command-and-control server address 264.

In response to the command-request data packet 144, the network communication module 230 can receive a command data packet 142 from the command-and-control server 140. The command data packet 142 can comprise a command to query the local database 104 (also referred to herein as the “target database”) for specific data elements 280. Additionally, in at least one implementation, the command data packet 142 also comprises additional commands and/or information, such as user authentication credentials and/or commands directed towards the data beacon 102. For example, the command data packet 142 can comprise an updated time frequency for the computer-based timer 240. The updated time frequency can change the particular time frequency at which the computer-based timer 240 repeatedly generates the initiation event.

In response to the command, the network communication module 230 and data packet processing module 250 can forward at least a portion of the command-request data packet 144 to the database processing module 270. The database processing module 270 then queries the local database 104 for the specific data elements 280. In at least one implementation, the database processing module 270 may utilize user authentication credentials received in the command data packet 240 when accessing the specific data elements 280. For instance, the local database 104 may enforce user permissions that requires specific user authentication credentials to access certain data elements.

Upon receiving the specific data elements from the database processing module 270, the data packet processing module 250 can generate a response data packet 146 that comprises the specific data elements 280. The network communication module 230 then transmits the response data packet 146 to the command-and-control server 140, using the command-and-control server address 264.

In contrast, to the above example where the data beacon software application 210 retrieved data from the local database 104, the data beacon software application 210 can also add information to the local database 104. For example, the network communication module 230 can receive a command data packet 142 from the command-and-control server 140 that comprises a command to add a particular dataset (not shown) to the local database 104. In response to the command, the database processing module 270 can access the local database 104 and add the particular dataset to the local database 104.

In various implementations, the command data packet 142 can comprise a network accessible address to the particular data set. For example, the particular dataset may be stored within a remote database (not shown). The command data packet 142 can also comprise user authentication data for accessing the particular dataset. In an alternative implementation, the command data packet 142 can comprise the particular data set itself.

In at least one implementation, the database processing module 270 can also perform one or more processing functions on the specific data elements 280. For example, the database processing module 270 can perform processing functions such as formatting, encrypting, verifying, and other similar functions. In alternative implementations, the database processing module 270 only retrieves data from the local database 104 and transmits the data.

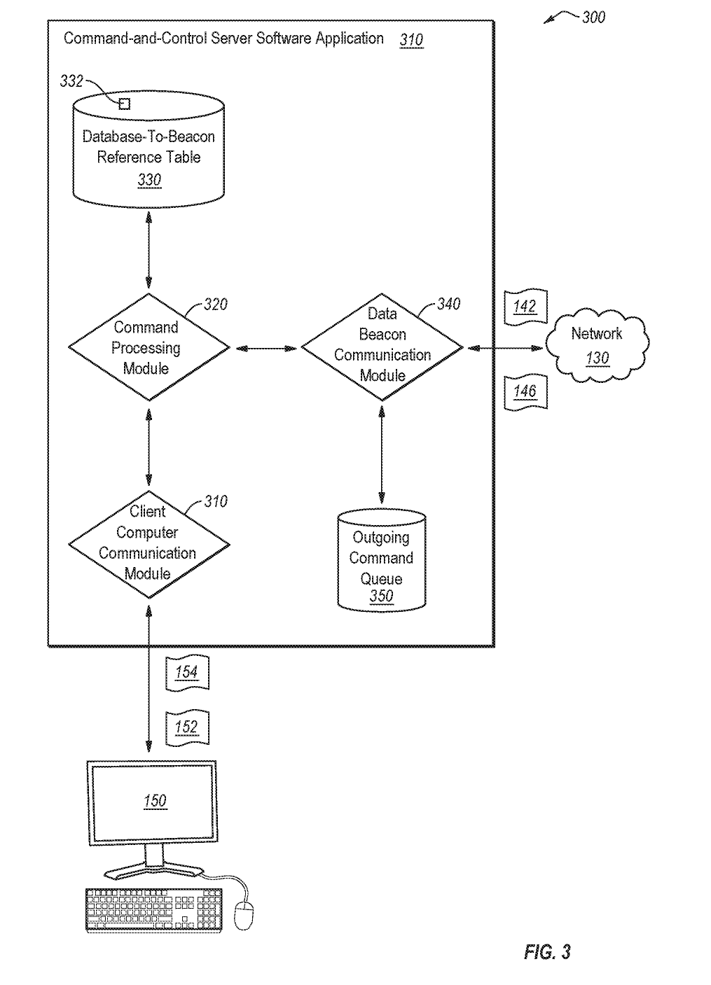

Turning now to FIG. 3, FIG. 3 depicts a schematic diagram of a portion of a system 300 for data packet communication between a command-and-control server 104 (shown in FIG. 1) and a data beacon 102 (shown in FIG. 1) that are located within separate networks in accordance with implementations of the present invention. In particular, FIG. 3 depicts a schematic diagram of modules within a command-and-control server software application 310. One of skill will understand that the depiction of the command-and-control server software application 310 is merely exemplary, and that in alternate implementations, the same functions can be performed with modules in a different arrangement and/or with equivalent hardware devices.

In at least one implementation, the command-and-control server software application 310 comprises a client computer communication module 310. The client computer communication module 310 can receive, from a client computer 150, a database command 152. The database command 152 can comprise a database identification indicator that designates a target database 104, a request for specific data elements 280 within the target database 104, and a data processing command. As used herein, when speaking of the database from the perspective of the command-and-control server 140 and the client computer 150, the database is referred to as the “target database.” In contrast, when speaking of the database from the perspective of the local network 160 and the data beacon, the database is referred to as the “local database.” One will understand that the target database and the local database comprise the same database and are thus referenced with the same numerical label of 104.

Once the database command 152 is received, the command processing module 320 can identify, from within a digitally stored database-to-beacon reference table 330, a target beacon identification indicator 332 for a data beacon 102 that is associated with the desired target database 104. For example, the database identification indicator may designate and/or describe a particular database of interest. The command processing module 320 can identify within the database-to-beacon reference table 330 a particular database that is designated and/or described by the database identification indicator. The database-to-beacon reference table 330 can then provide a target beacon identification indicator 332 for a data beacon 102 that has access to the desired target database 104.

The command processing module 320 can then generate a command data packet 142 that comprises a request for the specific data elements 280 within the target database 104. Additionally, the command processing module 320 can associate the command data packet 142 with the beacon identification indicator 332. The command processing module 320 can then store the command data packet 142 within an outgoing-command queue 350. The outgoing-command queue 350 may comprise a data structure of any type that is configured to at least temporarily store data (in this case command data packets).

In at least one implementation, the command-and-control server software application 310 can also comprise a data beacon communication module 340. The data beacon communication module 240 can receive a command-request data packet 144 from data beacon 102. The command-request data packet 144 can comprise the target beacon identification indicator 330 and the public network address for the target data beacon. The received target beacon identification indicator 330 may be equivalent to the beacon identification indicator 262 (shown in FIG. 2) that is transmitted by data beacon 102.

Upon receiving the command-request data packet 144, the data beacon communication module 340 can query the out-going command queue 350 for a command data packet 142 associated with the target beacon identification indicator 330. The data beacon communication module 340 can then transmit the command data packet 142 to the public network address for the data beacon 102 that is associated with the target database 104. In response to transmitting the command data packet 142, the data beacon communication module 340 can receive, from the data beacon 102, a response data packet 146. The response data packet 146 can comprise the specific data elements 280 (shown in FIG. 2) that were requested by the database command 152 from the client computer 150.

Once the requested specific data elements 280 have been received by the command-and-control server software application 210, the command processing module 320 can execute the data processing command, received from the client computer 150, on the specific data elements 280. For example, the data processing command may comprise various mathematical operations, database analytic operations, or in some cases, simply formatting the data. In any case, the command processing module 320 can manipulate the specific data elements 280 in whatever way a user at the client computer 150 desires.

The client computer communication module 310 can then send a resulting data packet 154 to the client computer 150 for display. The resulting data packet 154 comprises results of the execution of the data processing command on the specific data elements 280. Accordingly, a user can send a database command 152 from a client computer 150, which may be remote from both the local network 160 and the command-and-control server 140. The requested specific data elements 280 can be gathered from a local database 104, which otherwise may not be accessible from outside the local network 160, processed, and displayed at the client computer 150.

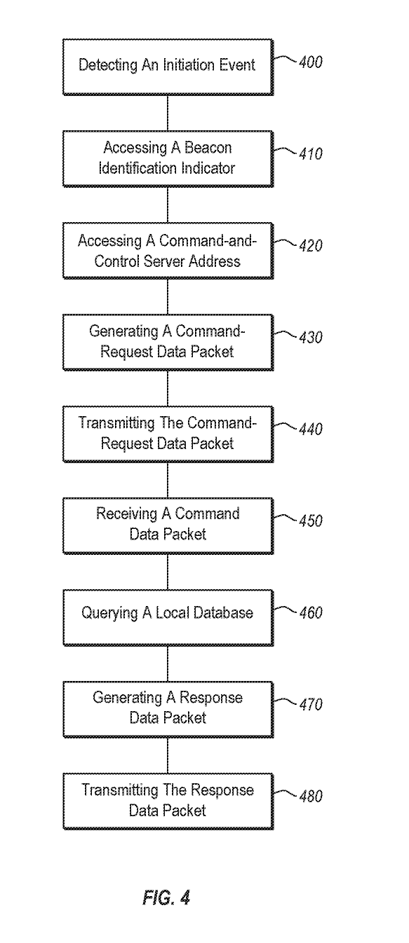

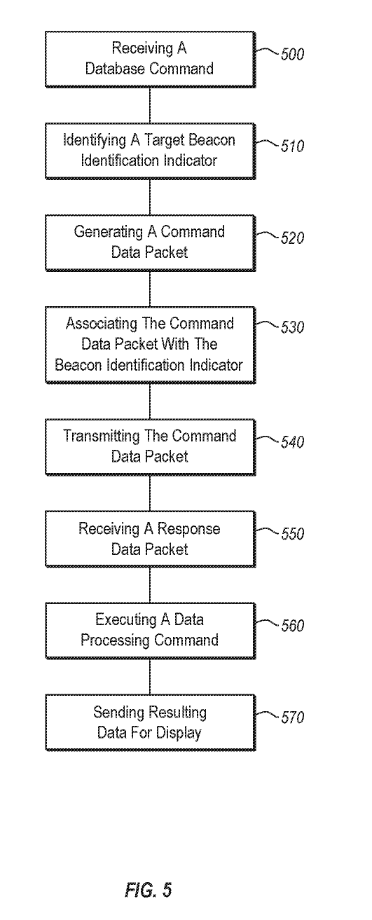

Accordingly, FIGS. 1-3 and the corresponding text illustrate or otherwise describe one or more components, modules, and/or mechanisms for communicating with a local database 104 that is within a local network 160. In particular, in at least one implementation, the present invention can communicate commands received from a client computer 150 to a data beacon 102 located within the local network of interest. The data beacon 102 can then gather the data of interest and communicate the data back to a command-and-control server 140. The command-and-control server 140 can process the data and provide the results back the client computer 150 for display. One will appreciate that implementations of the present invention can also be described in terms of flowcharts comprising one or more acts for accomplishing a particular result. For example, FIGS. 4 and 5 and the corresponding text describe acts in various systems for performing methods and/or stand-alone methods for data packet communication between a data beacon 102 and a command-and-control server 104 that are located within separate networks. The acts of FIGS. 4 and 5 are described below.

For example, FIG. 4 illustrates that a method for data packet communication between a data beacon 102 and a command-and-control server 140 that are located within separate networks can comprise an act 400 of detecting an initiation event. Act 400 can comprise detecting an initiation event generated by a computer-based timer. For example, as depicted and described in FIG. 2 and the accompanying description, the network communication module 230 can detect an initiation event generated by the computer-based timer 240. The computer-based timer 240 can generate the initiation event at a predetermined frequency.

FIG. 4 also illustrates that the method can include an act 410 of accessing a beacon identification indicator 262. Act 410 can comprise accessing, from the one or more computer-readable media, a beacon identification indicator 262, wherein the beacon identification indicator 262 comprises a pre-assigned identifier associated with the data beacon 102. For example, as depicted and described in FIG. 2 and the accompanying description, the data packet processing module 250 can access from within local memory 260 the beacon identification indicator 262.

Similarly, FIG. 4 illustrates that the method can include an act 420 of accessing a command-and-control server address 264. Act 420 can comprise accessing, from the one or more computer-readable media, a command-and-control server address, wherein the command-and-control server address comprises a public network address associated with a command-and-control server. For example, as depicted and described in FIG. 2 and the accompanying description, the data packet processing module 250 can access from within local memory 260 the command-and-control server address 264.

Additionally, FIG. 4 illustrates that the method can include an act 430 of generating a command-request data packet 144. Act 430 can comprise generating a command-request data packet comprising the beacon identification indicator 262 and a public network address associated with the data beacon. For example, as depicted and described in FIG. 2 and the accompanying description, the data packet processing module 250 can create the command-request data packet 144. The created command-request data packet 144 comprises both the beacon identification indicator 262 and the public network address associated with the data beacon.

FIG. 4 also illustrates that the method can include an act 440 of transmitting the command-request data packet 144. Act 440 can comprise transmitting the command-request data packet 144 to the command-and-control server address. For example, as depicted and described in FIG. 2 and the accompanying description, the network communication module 230 can transmit the command-request data packet 144 to the command-and-control server 140 over the network 130.

In addition, FIG. 4 illustrates that the method can include an act 450 of receiving a command data packet 142. Act 450 can comprise receiving a command data packet 142 from the command-and-control server 140, wherein the command data packet 142 comprises a command to query a local database 104 for specific data elements 280. For example, as depicted and described in FIG. 2 and the accompanying description, the network communication module 230 can receive the command data packet 142 from the network 130. The command data packet 142 can comprise a query directed towards local database 104.

FIG. 4 also illustrates that the method can include an act 460 of querying a local database. Act 460 can comprise querying the local database 104 for the specific data elements 280. For example, as depicted and described in FIG. 2 and the accompanying description, once the command data packet 142 is received and processed, the database processing module 270 can query the local database 104 for specific data element 280.

Further, FIG. 4 illustrates that the method can include an act 470 of generating a response data packet 146. Act 470 can comprise generating a response data packet 146, wherein the response data packet 146 comprises the specific data elements 280. For example, as depicted and described in FIG. 2 and the accompanying description, the data packet processing module 250 can create a response data packet 146 that includes the specific data elements 280 that were requested by the command data packet 142.

Further still, FIG. 4 illustrates that the method can include an act 480 of transmitting the response data packet 146. Act 480 can comprise transmitting the response data packet 146 to the command-and-control server address. For example, as depicted and described in FIG. 2 and the accompanying description, the network communication module 230 can transmit the response data packet 146 to the command-and-control server 140 over the network 130.

An additional implementation of the present invention can include a method for data packet communication between a command-and-control server 140 and a data beacon 102 that are located within separate networks. For example, FIG. 5 illustrates that a method for data packet communication between a command-and-control server 140 and a data beacon 102 that are located within separate networks can comprise an act 500 of receiving a database command. Act 500 can comprise receiving, from a client computer, a database command 152. The database command 152 comprises a database identification indicator that designates a target database 104, a request for specific data elements 280 within the target database 104, and a data processing command. For example, as depicted and described in FIG. 3 and the accompanying description, the client computer communication module 310 receives communications from a client computer 150. The received communications can comprise a database command 152 that includes a database identification indicator that designates a target database 104, a request for specific data elements 280 within the target database 104, and a data processing command.

FIG. 5 also illustrates that the method can include an act 510 of identifying a target beacon identification indicator 332. Act 510 can comprise identifying, from within a digitally stored database-to-beacon reference table 330, a target beacon identification indicator 332 for a data beacon 102 that is associated with the target database 104. For example, as depicted and described in FIG. 3 and the accompanying description, the command processing module 320 can access the database-to-beacon reference table 330 and retrieve a target beacon identification indicator 332.

Additionally, FIG. 5 illustrates that the method can include an act 520 of generating a command data packet 142. Act 520 can comprise generating a command data packet 142 that comprises the request for the specific data elements 280 within the target database 104. For example, as depicted and described in FIG. 3 and the accompanying description, the command processing module 320 can create a command data packet 142. The created command data packet 142 can include the request for the specific data elements 280 within the target database 104. In at least one implementation, the request for the specific data elements 280 within the target database 104 can comprise a database specific command, such as a SQL command.

FIG. 5 also illustrates that the method can include an act 530 of associating the command data packet 142 with the target beacon identification indicator 332. For example, as depicted and described in FIG. 3 and the accompanying description, the command processing module 320 can associate the command data packet 142 with the target beacon identification indicator 332. Associating the command data packet 142 with the target beacon identification indicator 332 can comprise storing the command data packet 142 with the target beacon identification indicator 332, embedding the command data packet 142 within the target beacon identification indicator 332, or otherwise creating a relationship between the command data packet 142 and the target beacon identification indicator 332.

In addition, FIG. 5 illustrates that the method can include an act 540 of transmitting the command data packet. Act 540 can comprise transmitting the command data packet 142 to a network address associated with the data beacon 102 that is associated with the target database 104. For example, as depicted and described in FIGS. 2 and 3 and the accompanying descriptions, the data beacon communication module 340 can transmit the command data packet 142 to the data beacon 102.

FIG. 5 also illustrates that the method can include an act 550 of receiving a response data packet 146. Act 560 can comprise receiving, from the data beacon 102, a response data packet 146, wherein the response data packet 146 comprises the specific data elements 280. For example, as depicted and described in FIG. 3 and the accompanying description, the data beacon communication module 340 can receive the response data packet 146 that was transmitted by the data beacon 102. The response data packet 146 can comprise the specific data elements 280 that were requested by the database command 152.

Further, FIG. 5 also illustrates that the method can include an act 560 of executing a data processing command. Act 560 can comprise executing the data processing command on the specific data elements 280. For example, as depicted and described in FIG. 3 and the accompanying description, the command processing module 320 can execute a data processing command, such as a mathematical or analytical command, on the specific data elements 280 that were received from the target database 104.

Further still, FIG. 5 also illustrates that the method can include an act 570 of sending resulting data for display. Act 570 can comprise sending the resulting data to the client computer 150 for display. For example, as depicted and described in FIG. 3 and the accompanying description, the client computer communication module 310 can send the resulting data, in the form of resulting data packet 154 to the client computer 150 for display.

Accordingly, as recited herein, implementations of the present invention provide significant technical advances to the art. In particular, implementations of the present invention provide systems and method for easily accessing database data across different isolated networks. Implementations of the present invention allow users to issue commands synchronously to the command-and-control server 140. The data beacons 102, 106 can then asynchronously access one or more databases 104, 108 in response to the user commands. As such, users can access and process information within databases without significantly altering network policies of a local network 160 where the target database 104 is located.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for data packet communication between a data beacon and a command-and-control server that are located within separate networks, comprising:
one or more processors; and
one or more computer-readable media having stored thereon executable instructions that when executed by the one or more processors configure the computer system to perform at least the following:
detect an initiation event generated by a computer-based timer;
access, from the one or more computer-readable media, a beacon identification indicator, wherein the beacon identification indicator comprises a pre-assigned identifier associated with the data beacon;
access, from the one or more computer-readable media, a command-and-control server address, wherein the command-and-control server address comprises a public network address associated with a command-and-control server;
generate a command-request data packet comprising the beacon identification indicator and a public network address associated with the data beacon;
transmit the command-request data packet to the command-and-control server address;
receive a command data packet from the command-and-control server, wherein the command data packet comprises a command to query a local database for specific data elements;
query the local database for the specific data elements;
generate a response data packet, wherein the response data packet comprises the specific data elements; and
transmit the response data packet to the command-and-control server address.

2. The computer system of claim 1, wherein the computer-based timer repeatedly generates the initiation event at a particular time frequency.

3. The computer system of claim 2, wherein the executable instructions include instructions that when executed configure the computer system to:
receive a command data packet from the command-and-control server, wherein the command data packet comprises an updated time frequency for computer-based timer, wherein the updated time frequency changes the particular time frequency at which the computer-based timer repeatedly generates the initiation event.

4. The computer system of claim 1, wherein the command data packet comprises user authentication credentials for accessing the local database.

5. The computer system of claim 1, wherein multiple data beacons are present within the same intranet and each of the multiple data beacons is in communication with a different local database.

6. The computer system of claim 1, wherein user commands are synchronously received by the command-and-control server while the data beacons asynchronously accesses one or more databases in response to the user commands.

7. The computer system of claim 1, wherein the executable instructions include instructions that when executed configure the computer system to:
receive a command data packet from the command-and-control server, wherein the command data packet comprises a command to add a particular dataset to the local database;
access the local database; and
add the particular dataset to the local database.

8. The computer system of claim 7, wherein the command data packet comprises a network accessible address to the particular data set.

9. The computer system of claim 7, wherein the command data packet comprises the particular data set.

10. The computer system of claim 7, wherein the command data packet comprises user authentication data for accessing the particular dataset.

11. A computer system for data packet communication between a command-and-control server and a data beacon that are located within separate networks, comprising:
one or more processors; and
one or more computer-readable media having stored thereon executable instructions that when executed by the one or more processors configure the computer system to perform at least the following:
receive, from a client computer, a database command, wherein
the database command comprises:
a database identification indicator that designates a target database,
a request for specific data elements within the target database, and
a data processing command;
identify, from within a digitally stored database-to-beacon reference table, a target beacon identification indicator for a data beacon that is associated with the target database;
generate a command data packet that comprises the request for the specific data elements within the target database;
associate the command data packet with the target beacon identification indicator;
transmit the command data packet to a network address associated with the data beacon that is associated with the target database;
receive, from the data beacon, a response data packet, wherein the response data packet comprises the specific data elements;
execute the data processing command on the specific data elements; and
send the resulting data to the client computer for display.

12. The computer system of claim 11, wherein the executable instructions include instructions that when executed configure the computer system to:
store the command data packet within an outgoing-command queue;
receive a command-request data packet, wherein the command-request data packet comprises the target beacon identification indicator and the public network address for the data beacon;
query the out-going command queue for the command data packet associated with the target beacon identification indicator; and
transmit the command data packet to the public network address for the data beacon.

13. The computer system of claim 12, wherein the command data packet comprises an updated time frequency for the data beacon, wherein the updated time frequency changes a particular time frequency at which the data beacon sends command-request data packets.

14. The computer system of claim 11, wherein database command comprises user authentication credentials for accessing the target database.

15. The computer system of claim 11, wherein the executable instructions include instructions that when executed configure the computer system to:
receive, from a client computer, another database command, wherein the other database command comprises:
a database identification indicator that designates the target database, and
a request to add a particular dataset to the target database.

16. The computer system of claim 15, wherein the other database command comprises the particular dataset.

17. The computer system of claim 15, wherein the other database command comprises a network accessible address to the particular data set.

18. The computer system of claim 15, wherein the command data packet comprises user authentication data for accessing the target database.

19. The computer system of claim 11, wherein database commands are synchronously received by the command-and-control server while the data beacons asynchronously accesses one or more databases in response to the database commands.

20. A computerized method for execution on a computer system, comprising one or more processors, system memory, and one or more computer-readable media storing computer-executable instructions, the method for data packet communication between a data beacon and a command-and-control server that are located within separate networks comprising the acts of:
accessing, from the one or more computer-readable media, a beacon identification indicator, wherein the beacon identification indicator comprises a pre-assigned identifier associated with the data beacon;
generating a command-request data packet comprising the beacon identification indicator and a public network address associated with the data beacon;
transmitting the command-request data packet to a command-and-control server address;
receiving a command data packet from the command-and-control server, wherein the command data packet comprises a command to query a local database for specific data elements;
querying the local database for the specific data elements;
generating a response data packet, wherein the response data packet comprises the specific data elements; and
transmitting the response data packet to the command-and-control server address.
